(19) United States
(12) Patent Application Publication
(10) Pub. No.: US 2025/0168105 A1
(43) Pub. Date: May 22, 2025

(54) MULTIPROTOCOL/MULTILAYER COMPATIBLE RELAY DEVICE, MULTIPROTOCOL/MULTILAYER COMPATIBLE RELAY PROGRAM, AND MULTIPROTOCOL/MULTILAYER COMPATIBLE RELAY METHOD

(71) Applicant: MAYA NET SOLUTIONS, Inc., Tokyo (JP)

(72) Inventors: Kiyoshi YANAGIMOTO, Tokyo (JP); Kouki KASUE, Tokyo (JP)

(73) Assignee: MAYA NET SOLUTIONS, Inc., Tokyo (JP)

(21) Appl. No.: 18/290,122

(22) PCT Filed: Jun. 19, 2023
(86) PCT No.: PCT/JP2023/022555

§ 371 Date: Jan. 6, 2025

(30) Foreign Application Priority Data
Dec. 13, 2022 (JP) 2022-198535

(51) Int. Cl. H04L 45/00; H04L 41/0681; H04L 43/0811; H04L 45/52

(52) U.S. Cl. CPC H04L 45/22; H04L 41/0681; H04L 43/0811; H04L 45/52

(57) ABSTRACT

To achieve a redundant mobile line anew while continuously using an operating function such as a security function of a communication device that is being used, without changing configuration settings of the communication device being used. Provided is a multiprotocol/multilayer compatible relay device that relays, to a second communication line, connection of a communication device that is connected to a first communication line, and the multiprotocol/multilayer compatible relay device includes: an interface that houses the first communication line; an interface that houses the second communication line of a communication scheme different from the first communication line; an interface connecting to the communication device; a failure/recovery detection unit; a transmission/reception path control unit; a first communication line transfer processing unit; and a second communication line transfer processing unit.

### TECHNICAL FIELD

The present invention relates to a multiprotocol/multilayer compatible relay device, a multiprotocol/multilayer compatible relay program, and a multiprotocol/multilayer compatible relay method capable of achieving a redundant network of a wired main line and a secondary line such as a mobile line in a simple manner.

### BACKGROUND ART

Recently, various tasks from a simple payroll calculation system to an accounting system, a sales management system, an inventory management system, a purchasing management system, a production management system, Web conferences, and the like are shifted from being handled by humans to computers (introduction of IT in each company) at an accelerated pace and each of such systems is operated via networks. Thus, network failures causes business stagnation, which results in a great loss in the companies. In order to overcome business stagnation caused by network failures, it is necessary to achieve redundant network lines with a wired main line and a mobile subline (wireless line) or the like.

In a conventional IP network such as the Internet using a wired line, for achieving redundancy with a mobile line in preparation for failures and the like in the wired line, there is means for replacing a router that is being used by being connected to the wired line with a relay device that enables network access via the wired line and the mobile line.

As an example, there is provided an M2M router that is compatible for both 4G/LTE mobile lines and fixed lines (wired lines) such as optical lines (see Non-Patent Literature 1). Each of the fixed (wired) line and the mobile line are set in the M2M router, and it is configured to continue communication by mutually switching the fixed (wired) line and the mobile line alternately when there is a failure in the communication line.

### CITATION LIST

### Non-Patent Literature

Non-Patent Literature 1: “M2M Router That Can Use Both Mobile and Fixed Lines in Preparation for Communication Line Failures”, [online], I-O DATA DEVICE, INC. [Searched on Oct. 17, 2022], Internet <URL: https://www.iodata.jp/ssp/magazine/265/index.htm>

### SUMMARY OF INVENTION

### Technical Problem

However, when Non-Patent Literature 1 described above is to be applied to an existing network, an existing router needs to be replaced with the M2M router. Thus, operating functions such as a security function of the router that is being used cannot be used continuously, and it is necessary to review and construct a new network design including configuration settings of the user terminal and the router being used. Therefore, it is difficult to achieve the redundant network in a simple manner.

### OBJECT OF INVENTION

The present invention is designed in view of such circumstances, and an object thereof is to achieve a redundancy with a new subline, which allows continuous use of an operating function such as a security function of a communication device that is being used (main line), and which requires no change or reset of configuration settings of the communication device that is being used (main line).

Another object of the present invention is to provide communication means capable of implementing continuous use of a network without causing disconnection by detecting a failure and recovery of the main line and controlling a transmission/reception path between the communication device and the main line or a subline by switching to the subline when there is a failure in the main line and switching to the main line when the main line recovers from the failure.

Still another object of the present invention is to provide effective means for achieving redundancy with a wired line and a mobile line by mutually converting communication formats even in a case where the wired line and the mobile line are of different communication connection methods.

### Solution to Problem

A multiprotocol/multilayer compatible relay device according to the present invention is a multiprotocol/multilayer compatible relay device that relays, to a second communication line, connection of a communication device that is connected to a first communication line, the multiprotocol/multilayer compatible relay device including: an interface that houses the first communication line; an interface that houses the second communication line of a communication scheme different from the first communication line; an interface connecting to the communication device; a failure/recovery detection unit that detects a failure and recovery of the first communication line; a transmission/reception path control unit that sets a value for performing mutual switching control of a transmission/reception path between the first communication line and the second communication line in accordance with a detection result acquired by the failure/recovery detection unit; a first communication line transfer processing unit that: transfers a packet received from the communication device to the interface that houses the first communication line; and transfers a packet received from the interface that houses the first communication line to the communication device; and a second communication line transfer processing unit that: converts a format of the packet received from the communication device and transfers the packet to the interface that houses the second communication line; and converts a format of the packet received from the interface that houses the second communication transfers the packet to the line and communication device, the multiprotocol/multilayer compatible relay device: relaying connection of the communication device to the second communication line by switching the transmission/reception path from the first communication line to the second communication line based on the value set by the transmission/reception path control unit, when the failure is detected by the failure/recovery detection unit; and relaying connection of the communication device to the first communication line by switching the transmission/reception path from the second communication line to the first communication line based on the value set by the transmission/reception path control unit, when recovery from the failure is detected by the failure/recovery detection unit.

In the multiprotocol/multilayer compatible relay device according to the present invention, in a case where the first communication line is a wired line, and the second communication line is a mobile line, the interface that houses the first communication line is a WAN-side NIC, the interface that houses the second communication line is a mobile communication unit, the interface connecting to the communication device is a LAN-side NIC, the wired line includes a wired line transfer processing unit that is the first communication line transfer processing unit, the wired line transfer processing unit including: a provider information analysis unit that analyzes a connection-destination provider of the wired line; a connection session analysis unit that analyzes a connection session with the wired line; and a transmission/reception packet analysis unit that analyzes a packet notified from the connection session analysis unit, the failure/recovery detection unit includes: a reception packet monitoring unit that monitors the packet from the wired line; a failure detection unit that detects a failure of the wired line; a recovery detection unit that detects recovery of the wired line; a mobile use information management that manages use information of the mobile line; and the transmission/reception path control unit, the mobile line includes a mobile line transfer processing unit that is the second communication line transfer processing unit, the mobile line transfer processing unit including: a provider searching processing unit that searches for a provider; a session establishing processing unit that establishes an Internet connection from the communication device to the wired line when there is a failure in the wired line; a session maintaining processing unit that maintains the Internet connection of an Internet-connected session; a mobile uplink packet conversion unit that converts a format of a transmission/reception packet that varies between a case of using the wired line and a case of using the mobile line, and transfers the transmission/reception packet to the mobile communication unit; and a mobile downlink packet conversion unit that converts a format of a transmission/reception packet that varies between the wired line and the mobile line, and transfers the transmission/reception packet to the LAN-side NIC.

In the multiprotocol/multilayer compatible relay device according to the present invention, the failure detection unit: generates a session maintaining request packet reception time from a latest session maintaining request packet received from the communication device; and when a session maintaining response packet is not received from the wired line within a prescribed time with respect to the session maintaining request packet reception time, detects and notifies non-reception to the transmission/reception path control unit, the reception packet monitoring unit: generates a packet reception time from a latest packet received from the wired line; and when a packet is not received from the wired line within a prescribed time with respect to the packet reception time, detects and notifies non-reception to the transmission/reception path control unit, the transmission/reception path control unit has a function of determining a failure based on notification from the failure detection unit and notification from the reception packet monitoring unit, and the failure detection unit has a function of detecting recovery of the wired line by trying to establish a session through requesting session connection to each of the connection-destination providers of the wired line.

In the multiprotocol/multilayer compatible relay device according to the present invention, the wired line transfer processing unit includes provider information management and transmission/reception packet information management, the provider information analysis unit: analyzes a packet exchanged between the communication device and the connection-destination provider of the wired line; and extracts provider information including connection-destination provider name, connection-destination account and password, connection authentication method, and IP address assigned from the provider, the transmission/reception packet analysis unit:

analyzes a packet transmitted/received between the communication device and the connection-destination provider of the wired line; and extracts transmission/reception packet information including connection protocol information, source IP address, destination IP address, and port number, the provider information management manages the provider information for each of the connection-destination providers of the wired line, and the transmission/reception packet information management manages the transmission/reception packet information for each of the connection-destination providers of the wired line.

In the multiprotocol/multilayer compatible relay device according to the present invention, the session maintaining processing unit includes means for maintaining a session through giving a session maintaining response in a pseudo manner for a session maintaining request given to the wired line from the communication device, when a failure of the wired line is detected, and the session establishing processing unit includes means for establishing, in a pseudo manner, an Internet-connection session from the communication device to the wired line by connecting a session in response to a new session connection request from the communication device to the wired line based on information including connection-destination provider, account, password, authentication method, and IP address.

In the multiprotocol/multilayer compatible relay device according to the present invention, the mobile uplink packet conversion unit includes means for converting a packet format of a communication packet transmitted from the communication device on the session that is established in a pseudo manner upon detecting the failure of the wired line into a packet format of a case that uses the mobile line based on information including source IP address, destination IP address, protocol, and port number transmitted/received on the provider, and the mobile downlink packet conversion unit includes means for converting a packet format of a communication packet transmitted from the mobile line into a packet format from the connection-destination provider of the wired line based on the information including the source IP address, the destination IP address, the protocol, and the port number transmitted/received on the provider.

In the multiprotocol/multilayer compatible relay device according to the present invention, the mobile use information management holds information including use start date/time and use end date/time of the mobile line as well as a traffic amount of the mobile line.

A multiprotocol/multilayer compatible relay program according to the present invention is a multiprotocol/multilayer compatible relay program for relaying, to a second communication line, connection of a communication device that is connected to a first communication line, the multiprotocol/multilayer compatible relay program causing a computer to execute: a failure/recovery detection function that detects a failure and recovery of the first communication line; a transmission/reception path control function that sets a value for performing mutual switching control of a transmission/reception path between the first communication line and the second communication line in accordance with a detection result acquired by the failure/recovery detection function; a first communication line transfer processing function that: analyzes a packet exchanged between the communication device and a connection-destination provider of the first communication line in accordance with a value for performing the switching control; extracts provider information, session information, and transmission/reception packet information; transfers a packet received from the communication device to an interface that houses the first communication line; and transfers a packet received from an interface that houses the first communication line to the communication device; and a second communication line transfer processing function that: analyzes the packet received from the communication device in accordance with the value for performing the switching control; converts a format of the packet received from the communication device into a format that can be transferred to the second communication line and transfers the packet to the interface that houses the second communication line; and converts a format of the packet received from the interface that houses the second communication line into a format that can be transferred to the communication device and transfers the packet to the communication device.

A multiprotocol/multilayer compatible relay method according to the present invention is a multiprotocol/multilayer compatible relay method for relaying, to a second communication line, connection of a communication device that is connected to a first communication line, the multiprotocol/multilayer compatible relay method causing a computer to execute: a failure/recovery detection step of detecting a failure and recovery of the first communication line; a transmission/reception path control step of setting a value for performing mutual switching control of a transmission/reception path between the first communication line and the second communication line in accordance with a detection result acquired by the failure/recovery detection step; a first communication line transfer processing step of: analyzing a packet exchanged between the communication device and a connection-destination provider of the first communication line in accordance with a value for performing the switching control; extracting provider information, session information, and transmission/reception packet information; transferring a packet received from the communication device to an interface that houses the first communication line; and transferring a packet received from an interface that houses the first communication line to the communication device; and a second communication line transfer processing step of: analyzing the packet received from the communication device in accordance with the value for performing the switching control; converting a format of the packet received from the communication device into a format that can be transferred to the second communication line and transferring the packet to the interface that houses the second communication line; and converting a format of the packet received from the interface that houses the second communication line into a format that can be transferred to the communication device and transferring the packet to the communication device.

### Advantageous Effects of Invention

According to the present invention, the connection is relayed to a plurality of lines including the first communication line and the second communication line, so that it is possible to maintain the connection of the network by switching to the second communication line even when there is a failure occurred in the first communication line.

According to the present invention, the connection-destination provider and the connection session are analyzed from the communication between the communication device and the first communication line (for example, wired line), so that it is possible to relay the communication device to the first communication line or the second communication line (for example, mobile line) without conducting initial settings on the multiprotocol/multilayer compatible relay device itself and without changing and resetting communication settings between the communication device and the first communication line.

According to the present invention, the transmission/reception path is controlled between the first communication line and the second communication line by detecting the failure and recovery, and the transmission/reception packets different for the wired line and the mobile line are transferred by converting the format. Therefore, even when there is a failure occurred in the wired line, it is possible to maintain the connection of the network by switching to the mobile line without requiring operations on the user side.

### BRIEF DESCRIPTION OF THE DRAWINGS

FIG. 1 is a system configuration diagram of a multiprotocol/multilayer compatible relay device according to an embodiment of the present invention;

FIG. 2 is a flowchart of packet transfer processing from a communication device according to the embodiment of the present invention;

FIG. 3 is a flowchart of packet transfer processing from a wired line according to the embodiment of the present invention;

FIG. 4 is a flowchart of packet transfer processing from a mobile line according to the embodiment of the present invention;

FIG. 5A is a flowchart of failure detection processing according to the embodiment of the present invention;

FIG. 5B is a flowchart of recovery detection processing according to the embodiment of the present invention;

FIG. 6 is a table configuration diagram of a provider information management according to the embodiment of the present invention;

FIG. 7 is a table configuration diagram of a transmission/reception packet information management according to the embodiment of the present invention;

FIG. 8 is a table configuration diagram of a mobile use information management according to the embodiment of the present invention; and

FIG. 9 is an overall block diagram according to the embodiment of the present invention.

### DESCRIPTION OF EMBODIMENTS

Hereinafter, a basic configuration of a multiprotocol/multilayer compatible relay device according to an embodiment of the present invention will be described with reference to the accompanying drawings. A multiprotocol/multilayer compatible relay program and a multiprotocol/multilayer compatible relay method according to the present embodiment are executed or achieved by using the multiprotocol/multilayer compatible relay device.

### Basic Configuration

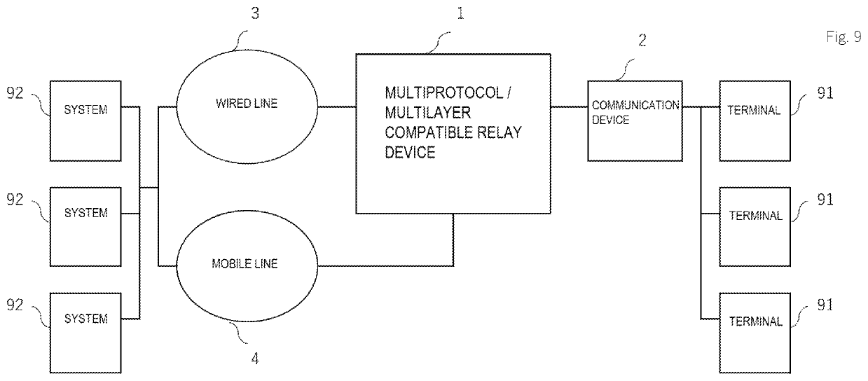

Referring to FIG. 9, an overall configuration that uses a multiprotocol/multilayer compatible relay device 1 will be described. While the present embodiment employs a mode in which a wired line is used as a first communication line and a mobile line is used as a second communication line, the present invention is not limited thereto.

The multiprotocol/multilayer compatible relay device 1 is a device that is configured to selectively relay a communication device 2 and a wired line 3 as a first communication line or a mobile line 4 as a second communication line, and relays communication between the communication device 2 and the wired line 3 or the mobile line 4 by reverse engineer by corresponding to multi-protocols and multi-layers.

The communication device 2 is, for example, a personal digital assistant, a mobile computer, other user terminals, a router, or a desktop computer having a communication function, and the present embodiment will be described by referring to a case of using a router. The communication device 2 as the router is a typical router that is used as a relay device mainly in a TCP/IP network such as the Internet, which is a device that analyzes information of network layers and determines whether to transfer data, transfer destination thereof, and the like. Furthermore, in the present embodiment, it is disposed and connected between a terminal 91 and the multiprotocol/multilayer compatible relay device 1. The communication device 2 may simply need to be a user terminal, a router, or the like with a function as a relay device that can be disposed between the terminal and the multiprotocol/multilayer compatible relay device, and which type is to be used may be determined in accordance with the mode of the embodiment.

The wired line 3 may be an Internet network, a wide area network, a site-to-site network (closed network), or the like connected to a server of a provider on an IP network using a wired line such as an optical line, and the present embodiment will be described by referring to a case of using the Internet network.

The mobile line 4 may be an Internet network, a wide area network, a site-to-site network (closed network), or the like connected to a server of a provider on an IP network using a mobile line, and has a different communication scheme from that of the wired line 3. The present embodiment will be described by referring to a case of using the Internet network.

The terminal 91 may be a PC (Personal Computer), a smartphone, a tablet, or the like, which is connected to the communication device 2 and connected to the wired line 3 or the mobile line 4 via the multiprotocol/multilayer compatible relay device 1 to be able to access various systems 92 via the network. The terminal 91 has an arbitrary configuration. As an example, when the communication device 2 is a user terminal, it is possible to employ a configuration without providing the terminal 91.

Note here that the communication device 2 and the terminal 91 are connected via a LAN (Local Area Network), and the wired line 3 or the mobile line 4 and a system 92 are connected via a WAN (Wide Area Network). A plurality of systems 92 are connected to each other via the WAN. In the description of the present embodiment, in regards to the multiprotocol/multilayer compatible relay device 1, “LAN side” means the side connected to the LAN or the side closer to the LAN, while “WAN side” means the side connected to the WAN or the side closer to the WAN.

The system 92 may be a business system, a server of a provider, other servers, or the like, which provides services in response to the requests from the terminal 91 via the network. It may simply need to be able to execute the present embodiment, and detailed explanations thereof are omitted.

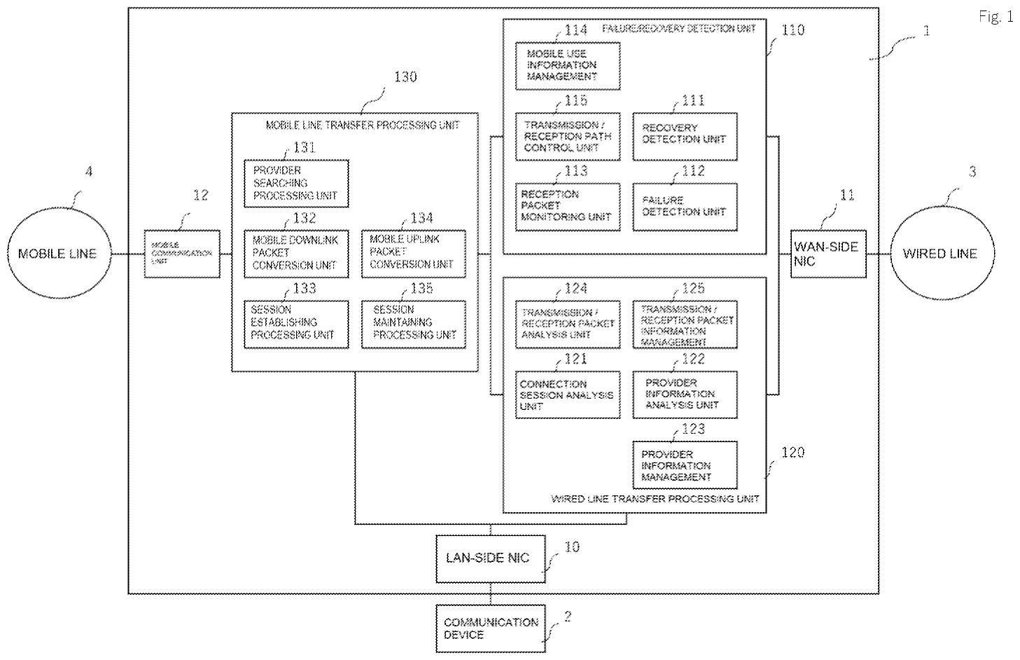

Next, by referring to FIG. 1, the system configuration of the multiprotocol/multilayer compatible relay device 1 will be described.

As described above by referring to FIG. 9, the multiprotocol/multilayer compatible relay device 1 is configured to relay each of the communication device 2, the wired line 3 or the mobile line 4.

Furthermore, in the present embodiment, described is a mode of configuration in which the multiprotocol/multilayer compatible relay device 1 is added to an existing configuration where the communication device (router) and one or more wired lines 3 are connected to achieve redundancy with the mobile line 4. However, in a case of using the communication device 2 and ADSL wired line 3, it is also possible to employ a configuration that relays the communication device 2 and the mobile line 4 when migrating from the ADSL to the mobile line.

As illustrated in FIG. 1, the multiprotocol/multilayer compatible relay device 1 is configured with a failure/recovery detection unit 110, a wired line transfer processing unit 120, a mobile line transfer processing unit 130, a LAN-side NIC 10, a WAN-side NIC 11, and a mobile communication unit 12.

The failure/recovery detection unit 110 includes: a recovery detection unit 111 that detects recovery of the wired line 3; a failure detection unit 112 that detects failures of the wired line 3; a reception packet monitoring unit 113 that monitors packets (communication packets) of the wired line 3; a mobile use information management 114 that manages information of the mobile line 4; and a transmission/reception path control unit 115 that performs mutual switching control of transmission/reception path between the wired line 3 and the mobile line 4. With such a configuration, the failure/recovery detection unit 110 detects the failure and recovery of the wired line 3, and performs switching control of the transmission/reception path between the communication device 2 and the wired line 3 or the mobile line 4.

The wired line transfer processing unit 120 is a first communication line transfer processing unit, which includes: a connection session analysis unit 121 that analyzes a connection session with the wired line 3; a provider information analysis unit 122 that analyzes a connection-destination provider; a provider information management 123 that manages provider information for each of the connection-destination providers; a transmission/reception packet analysis unit 124 that analyzes a packet to be transmitted/received (communication packet); and a transmission/reception packet information management 125 that manages transmission/reception packet information for each of the connection-destination providers. With such a configuration, the wired line transfer processing unit 120 has means for transferring the packet received from the communication device 2 to the WAN-side NIC 11, and transferring the packet received from the WAN-side NIC 11 to the communication device 2.

The transmission/reception packet information is information analyzed from the packets transmitted/received between the communication device 2 and the wired line 3 on a connection-destination provider, which is treated as connection n protocol information including information of protocol of the wired line 3 connected to the communication device 2, and information including source IP address, destination IP address, and port number.

The mobile line transfer processing unit 130 is a second communication line transfer processing unit, which includes: a provider searching processing unit 131 that searches for the provider; a mobile downlink packet conversion unit 132 that performs format conversion of the transmission/reception packet (communication packet) different for the wired line 3 and the mobile line 4, and transfers it to the LAN-side NIC 10; a session establishing processing unit 133 that establishes Internet connection from the communication device 2 to the wired line 3 when there is a failure in the wired line 3; a mobile uplink packet conversion unit 134 that performs format conversion of the transmission/reception packet different for a case of using the wired line 3 and for a case of using the mobile line 4, and transfers it to the mobile communication unit 12; and a session maintaining processing unit 135 that maintains the Internet connection for the Internet-connected session. With such a configuration, the mobile line transfer processing unit 130 transfers the packet received from the communication device 2 to the LAN-side NIC 10, and transfers the packet received from the LAN-side NIC 10 to the communication device 2.

The LAN-side NIC 10 is an interface connecting to the communication device 2, which is a network interface card (NIC) on the LAN side. While the NIC is used in the present embodiment, it may be any interface that connects to the communication device 2.

The WAN-side NIC 11 is an interface that houses the wired line (first communication line) 3, which is a network interface card (NIC) on the WAN side. While the NIC is used in the present embodiment, it may be any interface that houses the wired line.

The mobile communication unit 12 is an interface that houses the mobile line 4, which is configured with a function unit that establishes connection with the provider of the mobile line by IPoEV4, and performs IPV4 transmission/reception processing with the mobile line.

The configurations of each of the units are presented above as the basic configurations, which are not limited to those described above and may be configured in accordance with the mode of the embodiment.

### Embodiment

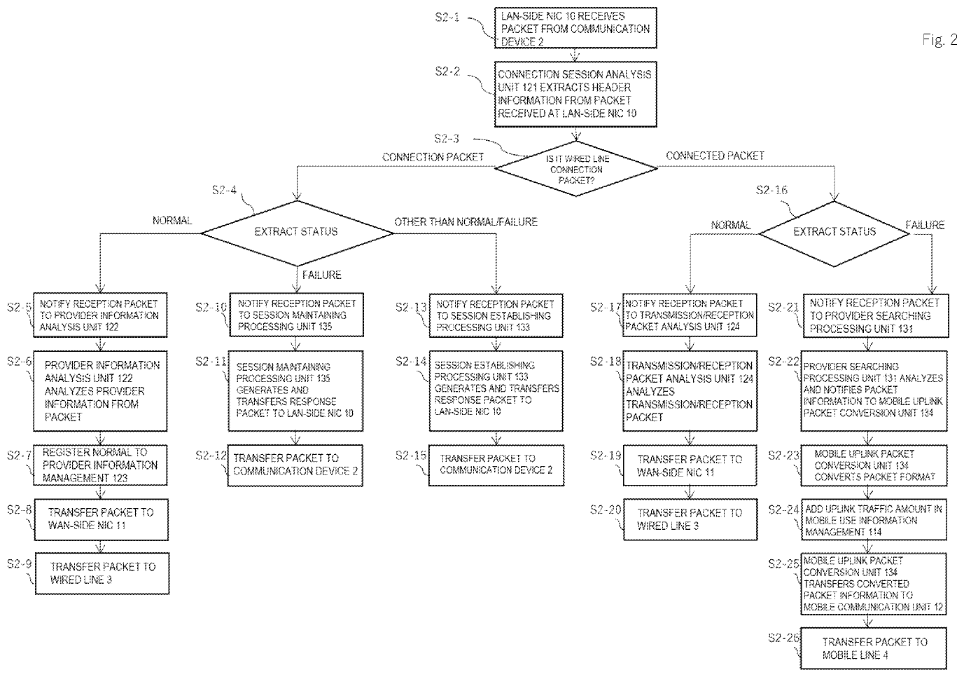

Next, the embodiment of the multiprotocol/multilayer compatible relay device 1 will be described by referring to FIG. 2 to FIG. 8.

Described by referring to FIG. 2 is a flow of packet transfer processing for transferring a packet received from the communication device 2 to the wired line 3 or the mobile line 4.

The LAN-side NIC 10 receives the packet from the communication device 2 (step S2-1 in FIG. 2). The connection session analysis unit extracts 121 session information including header information from the packet received at the LAN-side NIC 10 by reverse engineer (step S2-2 in FIG. 2). The session information of the present embodiment is considered to include header information and the like such as Ethernet header, PPPOE header, PPP header, and PPP payload.

Note that reverse engineer is similar to reverse engineering. Reverse engineering normally means to conduct disassembly, analysis, and the like of a product and reveal the structure and operating principle, whereas reverse engineer in the present embodiment is considered to analyze the packet that goes through the wired line 3 and extracts and analyze necessary information.

The connection session analysis unit 121 analyzes whether it is an Internet-connection packet or a connected packet on the wired line 3 from the extracted session information (header information and the like) (step S2-3 in FIG. 2).

In the present embodiment, when EtherType of the Ethernet header extracted in step S2-2 of FIG. 2 is PPP session, and protocol of the PPP header is LCP, Password Authentication Protocol (hereinafter, abbreviated as PAP), Challenge Handshake Authentication Protocol (hereinafter, abbreviated as CHAP), or Internet Protocol Control Protocol (IPCP), it is determined as the Internet-connection packet on the wired line 3. As an example, a session maintaining request (echo request) for maintaining the session from the communication device (route) 2 to the wired line 3 corresponds to the Internet-connection packet.

When the EtherType of the Ethernet header extracted in step S2-2 of FIG. 2 is PPP session, protocol of the PPPOE header is PPP session, protocol of the PPP header is IP, and the packet is received at the LAN-side NIC 10 from the terminal 91 via the communication device 2, it is determined as the Internet-connected packet on the wired line 3. As an example, a case determined as the Internet-connected packet on the wired line 3 corresponds to a case of receiving a request from the user terminal. When the communication device 2 is the terminal 91 (user terminal), the above-described condition “case of the packet received at the LAN-side NIC 10 from the terminal 91 via the communication device 2” is set to “case of the packet received at the LAN-side NIC 10 from the communication device 2”. The condition is set as appropriate in accordance with the mode of the embodiment.

When it is determined to be the Internet-connection packet on the wired line 3 as a result of analysis in step S2-3 of FIG. 2 (connection packet, step S2-3 in FIG. 2), the connection session analysis unit 121 searches for the provider session ID in the provider information management 123 by using the session identifier of the PPPOE header extracted in step S2-2 of FIG. 2 as a key, and extracts the status (Step S2-4 in FIG. 2).

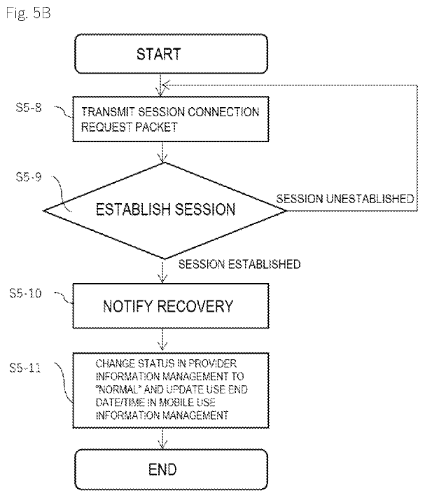

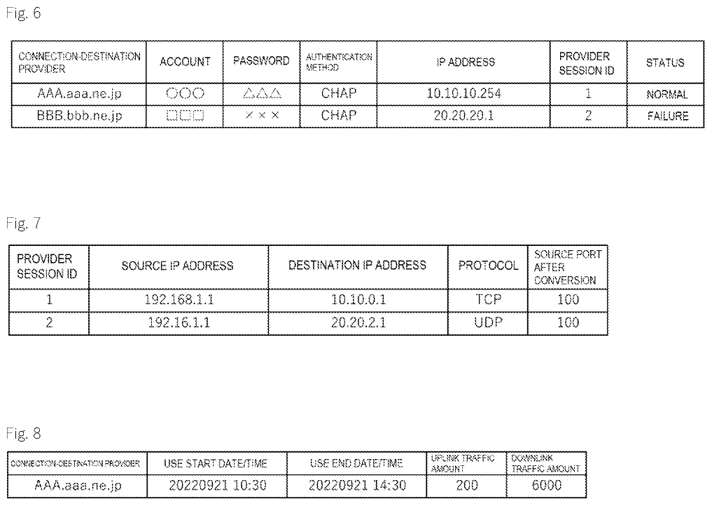

The provider information management 123 is a configuration for managing the provider information and, in the present embodiment, holds the provider information in a table structure as indicated in FIG. 6. Items such as connection-destination provider, connection-destination account, password, authentication method (connection authentication method), IP address, provider session ID, and status are held therein as the provider information.

As an example, when the session identifier of the PPPOE header extracted in step S2-2 of FIG. 2 is “1”, the provider whose provider session ID in the provider information management 123 indicated in FIG. 7 is “1” is extracted, and the status “normal” of the provider is extracted. Furthermore, when the session identifier is “2”, the provider whose provider session ID in the provider information management 123 is “2” is extracted, and the status “failure” of the provider is extracted.

Note that failures of the wired line 3 are considered to include not only physical failures of the device and line but also defects on the provider side as well as abnormality in connection such as bad connection with the line. Furthermore, “the wired line 3 is normal” is considered that a session between the communication device 2 and the wired line 3 is being established.

When the status extracted in step S2-4 of FIG. 2 is normal (normal, step S2-4 in FIG. 2), the connection session analysis unit 121 notifies the reception packet received in step S2-1 of FIG. 2 to the provider information analysis unit 122 (step S2-5 in FIG. 2).

The provider information analysis unit 122: analyzes the provider information such as the connection-destination provider, account, password, authentication method, IP address, and session ID from the packet (step S2-6 in FIG. 2); performs IPCP negotiation; determines that the Internet-connection session with the wired line 3 is completed upon completion of the negotiation; and registers “normal” to the status of the provider in the provider information management 123 searched in step S2-4 of FIG. 2 (step S2-7 in FIG. 2).

The provider information analysis unit 122 transmits the packet received in step S2-1 of FIG. 2 to the WAN-side NIC 11 (step S2-8 in FIG. 2), and the WAN-side NIC 11 transfers the packet to the wired line 3 (step S2-9 in FIG. 2).

Steps S2-1 to S2-9 in FIG. 2 described above are the flow of processing performed when a session maintaining request from the communication device 2 is transmitted properly to the wired line.

When the status extracted in step S2-4 of FIG. 2 is failure (failure, step S2-4 in FIG. 2), the connection session analysis unit 121 notifies the received packet to the session maintaining processing unit 135 (step S2-10 in FIG. 2). The session maintaining processing unit 135 analyzes the packet and, when it is a session maintaining request for maintaining the session, generates a session maintaining response packet and transfers it to the LAN-side NIC 10 (step S2-11 in FIG. 2). The LAN-side NIC 10 transfers the packet to the communication device 2 (step S2-12 in FIG. 2).

Steps S2-10 to S2-12 in FIG. 2 described above are the flow of processing performed when there is a failure in the wired line 3. By the processing, the session maintaining processing unit 135 gives, in a pseudo session maintaining response for maintaining the session in response to the session maintaining request for the wired line 3 received from the communication device 2, thereby making it possible to maintain the connected session between the communication device 2 and the wired line 3 even when there is a failure in the wired line 3.

When the status extracted in step S2-4 of FIG. 2 is other than normal and failure (other than normal and failure, step S2-4 in FIG. 2), the connection session analysis unit 121 notifies the received packet to the session establishing processing unit 133 (step S2-13 in FIG. 2). In response to the session connection request for establishing a new connection from the communication device 2 to the wired line 3, the session establishing processing unit 133 gives a session connection response for establishing connection based on the information including the connection-destination provider, account, password, authentication method, and IP address to establish an Internet-connection from session the communication device 2 to the wired line 3 in a pseudo manner, and transfers the packet to the LAN-side NIC 10 (step S2-14 in FIG. 2). The LAN-side NIC 10 transfers the packet to the communication device 2 (step S2-15 in FIG. 2).

An example of the processing content of step S2-14 in FIG. 2 will be described below.

A discovery stage response packet of PPPOE Active Discovery Offer (PADO) is generated for a discovery stage request packet of PPPOE Active Discovery Initiation (PADI) from the communication device 2 via the LAN-side NIC 10, a discovery stage response packet of PPPOE Active Discovery Session-confirmation is generated for a discovery stage request packet of PPPOE Active Discovery Request, and the packet is transferred to the LAN-side NIC 10.

Furthermore, a PPP session response packet of LCP is generated for a PPP session request packet of LCP from the communication device 2 via the LAN-side NIC 10, a PPP session response packet of a password authentication protocol (PAP or CHAP) is generated for a PPP session request packet of a password authentication protocol (PAP or CHAP), a PPP session response packet of IPCP packet is generated for a PPP session request packet of IPCP packet, and the packet is transferred to the LAN-side NIC 10.

When the PPP session request packet is analyzed and determined that the protocol of the PPP header is the LCP packet, the provider authentication method (PAP or CHAP) is extracted from the PPP payload part. When the protocol of the PPP header is password authentication, the account, password, and connection-destination provider are extracted from the PPP payload part to check that those match the connection-destination provider, account, and password indicated in the provider information management in FIG. 6. When the protocol of the PPP header is IPCP, a packet is generated with the global IP address managed in the mobile communication unit 12 for the IP address assigned to the communication device 2.

It is determined that the Internet-connection session with the wired line 3 is completed upon completion of the negotiation of IPCP, and the connection-destination provider, account, password, authentication method, IP address, and the provider session ID as well as the status “normal” are registered in the provider information management 123 indicated in FIG. 6.

Steps S2-13 to S2-15 in FIG. 2 described above are the flow of processing performed in a case other than normal and failure of the wired line 3. For example, the processing is executed at the time of initial connection when the multiprotocol/multilayer compatible relay device 1 is placed between the communication device 2 and the wired line 3.

The processing makes it possible to establish a new connection between the communication device 2 and the wired line 3. Furthermore, by analyzing the session connection request t (PPP session request) packet and extracting the provider information in the session establishing processing in step S2-14, the communication device 2 and the wired line 3 can be connected without conducting initial settings and the like on the multiprotocol/multilayer compatible relay device 1.

When it is determined as a result of analysis in step S2-3 of FIG. 2 to be an Internet-connected packet on the wired line 3 (connected packet, step S2-3 in FIG. 2), the connection session analysis unit 121 searches for the provider session ID in the provider information management 123 by using the session identifier of the PPPOE header extracted in step S2-2 of FIG. 2, and extracts the status of the data (step S2-16 in FIG. 2). The method for extracting the status is the same processing as that of step S2-4 in FIG. 2, so that the explanations thereof are omitted.

When the status extracted in step S2-16 of FIG. 2 is normal (normal, step S2-16 in FIG. 2), the connection session analysis unit 121 notifies the received packet to the transmission/reception packet analysis unit 124 (step S2-17 in FIG. 2). The transmission/reception packet analysis unit 124 analyzes the packet by reverse engineer, and manages the transmission/reception packet information such as the source IP address, destination IP address, protocol, and port number for each provider (step S2-18 in FIG. 2).

An example of analysis content executed in step S2-18 in FIG. 2 will be described below.

The transmission/reception packet analysis unit 124 extracts the provider session ID from the session identifier of the PPPOE header, extracts the source of the IP header, destination IP address, and protocol number and, when the protocol is Transmission Control Protocol (hereinafter, abbreviated as TCP) and User Datagram Protocol (hereinafter, abbreviated as UDP), extracts the source port numbers of the TCP header and the UDP header.

When the protocol extracted by the transmission/reception packet analysis unit 124 is the packet of TCP or UDP and also the combination of the source IP address, destination IP address, protocol, and destination port number does not match the source IP address, destination IP address, protocol, and converted source port number managed in the transmission/reception packet information management 125 indicated in FIG. 7, the extracted information is registered in the provider information management 123 with the addition of the provider session ID, source IP address, destination IP address, protocol, and source port number in the transmission/reception packet information management 125 indicated in FIG. 7.

The transmission/reception packet information management 125 is a configuration for managing information of the transmission/reception packets and, in the present embodiment, holds the transmission/reception packet information in a table structure as indicated in FIG. 7. Items such as provider session ID, source IP address, destination IP address, protocol, and source port number are held therein as the transmission/reception packet information.

When the protocol extracted by the transmission/reception packet analysis unit 124 is the packet of other than TCP or UDP and also the combination of the source IP address, destination IP address, and protocol does not match the source IP address, destination IP address, and protocol managed in the transmission/reception packet information management 125 indicated in FIG. 7, the extracted information is registered in the provider information management 123 with the addition of the provider session ID, source IP address, destination IP address, and protocol in the transmission/reception packet information management 125 indicated in FIG. 7.

The information acquired by analysis and extraction described above is merely an example, and may be determined as appropriate in accordance with the mode of embodiment.

After step of S2-18 FIG. 2, the transmission/reception packet analysis unit 124 transfers the packet received from the communication device 2 to the WAN-side NIC 11 (step S2-19 in FIG. 2), and the WAN-side NIC 11 transfers it to the wired line 3 (step S2-20 in FIG. 2).

Steps S2-17 to S2-20 in FIG. 2 described above are the flow of processing when transferring communication from the communication device 2 to the wired line 3, which makes it possible in the present embodiment to transmit the request from the terminal 91 to the wired line 3.

When the status extracted in step S2-16 of FIG. 2 is failure (failure, step S2-16 in FIG. 2), the connection session analysis unit 121 notifies the received packet to the provider searching processing unit 131 (step S2-21 in FIG. 2). The provider searching processing unit 131 analyzes the packet by reverse engineer, the extracted/converted packet to the mobile uplink packet conversion unit 134 (step S22-2 in FIG. 2).

An example of analysis content executed in step S2-22 in FIG. 2 will be described below.

The provider searching processing unit 131 analyzes the packet that is received at the LAN-side NIC 10 from the communication device 2 and notified from the connection session analysis unit 121, extracts the session identifier of the PPPOE header, the source IP address of the IP header, the destination IP address of the IP header, and the protocol number and, when the protocol is TCP or UDP, extracts the source port number of the TCP header or the UDP header.

When the protocol is the packet of TCP or UDP and also the combination of the source IP address, destination IP address, protocol, and source port number matches the provider session ID, source IP address, destination IP address, protocol, and source port number managed in the transmission/reception packet information management 125 indicated in FIG. 7, the received packet as well as the provider session ID, source IP address, destination IP address, protocol, source port number, and converted source port number managed in the transmission/reception packet information management 125 indicated in FIG. 7 are notified to the mobile uplink packet conversion unit 134.

Furthermore, when the converted port number managed in the transmission/reception packet information management 125 indicated in FIG. 7 is blank, the converted source port number that is unused under the same provider session ID, source IP address, and destination address is generated, and the generated source port number is registered to the converted source number in the transmission/reception packet information management 125 indicated in FIG. 7.

When the protocol is the packet of other than TCP or UDP and also the combination of the source IP address, destination IP address, and protocol matches the provider session ID, source IP address, destination IP address, and protocol managed in the transmission/reception packet information management 125 indicated in FIG. 7, the received packet as well as the provider session ID, source IP address, destination IP address, and protocol managed in the transmission/reception packet information management 125 indicated in FIG. 7 are notified to the mobile uplink packet conversion unit 134.

The packet that is received from the mobile line 4 at the mobile communication unit 12 and notified from the connection session analysis unit 121 is analyzed, the source IP address of the IP header is extracted as the destination address, the destination address is extracted as the source IP address, and the protocol number is extracted. When the protocol is TCP or UDP, the destination port number of the TCP header or the UDP header is extracted.

After step S22-2 of FIG. 2, the mobile uplink packet conversion unit 134 removes the PPPOE header and the PPP header, and converts the packet format based on the information notified from the provider searching processing unit 131 (step S2-23 in FIG. 2). In the present embodiment, when the protocol notified from the provider searching processing unit 131 is TCP or UDP, the PPP header and the PPPOE header are removed from the received packet and the source port number of the TCP or UDP header is replaced with the converted source port number. When the protocol is other than TCP or UDP, the PPP header and the PPPOE header are removed from the reception packet.

Next, the mobile uplink packet conversion unit 134 adds the uplink traffic amount in the mobile use information management 114 (step S2-24 in FIG. 2). In the present embodiment, the connection-destination provider name whose provider session ID managed in the provider information management 123 in FIG. 6 matches the provider session ID notified from the provider searching processing unit 131 is searched, the size of the received packet is added to the uplink traffic amount under the connection-destination provider name managed in the mobile use information management 114 of FIG. 8 matching the searched connection-destination provider name, and the uplink traffic amount managed in the mobile use information management 114 of FIG. 8 is changed to the added value.

The mobile use information management 114 is a configuration for managing the use information of the mobile line 4 and, in the present embodiment, holds the use information of the mobile line 4 in a table structure as indicated in FIG. 8. Items such as the connection-destination provider, use start date/time, use end date/time, uplink traffic amount, and downlink traffic amount are held therein as the use information of the mobile line 4.

Then, the mobile uplink packet conversion unit 134 transfers the packet extracted and converted in step S2-23 of FIG. 2 to the mobile communication unit 12 (step S2-25 in FIG. 2), and the mobile communication unit 12 transfers it to the mobile line 4 (step S2-26 in FIG. 2).

Steps S2-21 to S2-26 in FIG. 2 described above are the flow of processing performed when relaying communication from the communication device 2 to the mobile line 4 in a case of a failure occurred in the wired line 3. By the processing, the communication device 2 (user side) can have the Internet communication by connecting to the mobile line 4 without being aware of a failure even when the wired line 3 has the failure. Furthermore, since the provider searching processing unit 131 analyzes the packet received from the communication device 2 and the mobile uplink conversion unit 134 converts the packet into a packet format that can be transferred to the mobile line, the user side can use the mobile line 4 without conducting any special settings and the like.

Furthermore, by adding the traffic amount to the mobile line 4 to the mobile use information management 114, it is possible to manage the traffic amount of the mobile line 4 without the user side being aware at the time of using the mobile line.

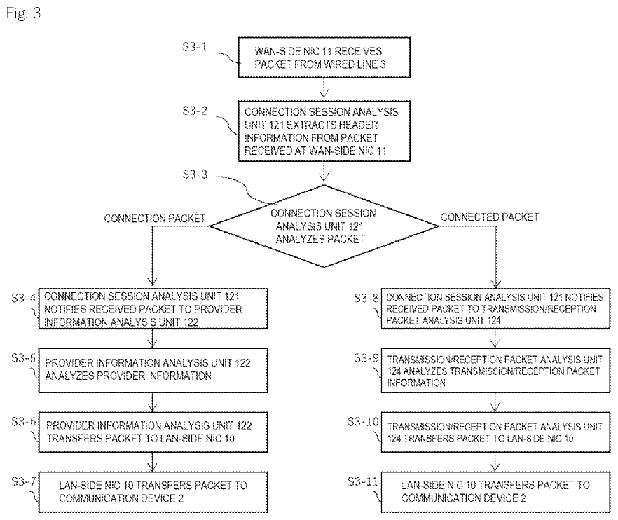

Next, a flow of packet transfer processing for transferring the packet received from the wired line 3 to the communication device 2 will be described by referring to FIG. 3.

The wired line 3 transmits the packet to the WAN-side NIC 11 (step S3-1 in FIG. 3). The connection session analysis unit 121, by reverse engineer, extracts the session information (header information and the like) from the packet received at the WAN-side NIC 11 (step S3-2 in FIG. 3). As an example, the Ethernet header, PPPOE header, PPP header, and PPP payload are extracted from the packet as the session information (header information and the like).

The connection session analysis unit 121 analyzes whether the packet is a connection packet or a connected packet from the extracted session information (step S3-3 in FIG. 3).

As an example, when the PPP header is analyzed from the extracted session information as LCP, PAP/CHAP, or IPCP, it is determined as a connection packet. The connection packet is a session maintaining response for a session maintaining request, and it is considered in the present embodiment as a packet of the session maintaining response for the session maintaining request from the communication device 2 in steps S2-1 to S2-9 of FIG. 2.

When the PPP header is analyzed as IP from the extracted session information, it is determined as a connected packet. The connected packet is a response of the wired line 3 for a request from the communication device 2, and it is considered in the present embodiment as a response packet from the system 92 for the request from the terminal 91 in steps S2-17 to S2-20 of FIG. 2.

When the packet analyzed in step S3-3 of FIG. 3 is the connection packet (connection packet, step S3-3 in FIG. 3), the connection session analysis unit 121 notifies the packet received in step S3-1 of FIG. 3 to the provider information analysis unit 122 (step S3-4 in FIG. 3). The provider information analysis unit 122 analyzes, by reverse engineer, the provider information such as the connection-destination provider, account, password, authentication method, IP address, and session ID (step S3-5 in FIG. 3).

An example of analysis content executed in step S3-5 of FIG. 3 will be described below.

The provider information analysis unit 122 analyzes the packet notified from the connection session analysis unit 121 and, when it is the PPP header of LCP, extracts the provider authentication method (PAP or CHAP) from the PPP payload part. The provider information analysis unit 122 extracts the account, password, and the connection-destination provider from the PPP payload part when the protocol of the PPP header is a password authentication protocol, and extracts the IP address from the PPP payload part and extracts the provider session ID from the session identifier of the PPPOE header when the protocol of the PPP header is IPCP.

After step S3-5 of FIG. 3, the provider information analysis unit 122 transfers the packet received in step S3-1 of FIG. 3 to the LAN-side NIC 10 (step S3-6 in FIG. 3), and the LAN-side NIC 10 transfers the packet to the communication device 2 (step S3-7 in FIG. 3).

The processing in steps S3-1 to S3-7 of FIG. 3 described above is the flow of processing performed when Internet-connecting the wired line 3 and the communication device 2, which makes it possible in the present embodiment to return a session maintaining response from the wired line 3 to the communication device 2.

When the packet is the connected packet (connected packet, step S3-3 in FIG. 3), the connection session analysis unit 121 notifies the received packet to the transmission/reception packet analysis unit 124 (step S3-8 in FIG. 3). The transmission/reception packet analysis unit 124 analyzes the packet by reverse engineer (step S3-9 in FIG. 3), and registers the transmission/reception packet information such as the source IP address, destination IP address, protocol, and port number to the transmission/reception packet information management 125 for each provider. The transmission/reception packet analysis unit 124 transfers the packet received in step S3-1 of FIG. 3 to the LAN-side NIC 10 (step S3-10 in FIG. 3), and the LAN-side NIC 10 transfers the packet to the communication device 2 (step S3-11 in FIG. 3).

The processing in steps S3-8 to S3-11 of FIG. 3 described above is the flow of communication processing from the wired line 3 to the communication device 2, which makes it possible in the present embodiment to return a response packet from the system 92 to the terminal 91 via the wired line 3.

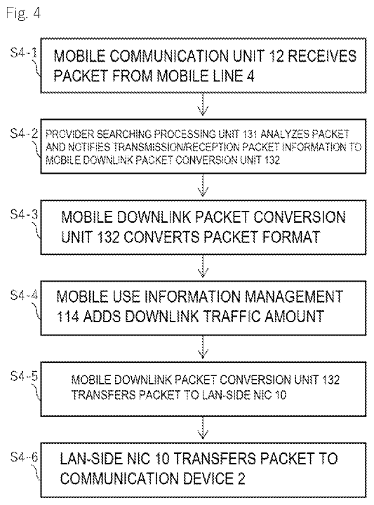

Next, a flow of packet transfer processing for transferring the packet received from the mobile line 4 to the communication device 2 will be described by referring to FIG. 4.

The mobile communication unit 12 receives a packet from the mobile line 4 (step S4-1 in FIG. 4). The provider searching processing unit 131, by reverse engineer, analyzes the packet received from the mobile line 4 and notifies the transmission/reception packet information to the mobile downlink packet conversion unit 132 (step S4-2 in FIG. 4).

An example of analysis content executed in step S4-2 of FIG. 4 will be described below.

The provider searching processing unit 131 analyzes the packet received from the mobile line 4, extracts the session identifier of the PPPOE header, the source IP address of the IP header, the destination IP address of the IP header, and the protocol number, and extracts the source port numbers of the TCP header or the UDP header when the protocol is TCP or UDP.

When the protocol is the packet of TCP or UDP and also the combination of the source IP address, destination IP address, protocol, and destination port number matches the source IP address, destination IP address, protocol, and converted source port number managed in the transmission/reception packet information management 125 indicated in FIG. 7, the received packet as well as the provider session ID, source IP address, destination IP address, protocol, source port number, and converted source port number managed in the transmission/reception packet information management 125 indicated in FIG. 7 are notified to the mobile downlink packet conversion unit 132.

When the protocol is the packet of other than TCP or UDP and the combination of the source IP address, destination IP address, and protocol matches the source IP address, destination IP address, and protocol managed in the transmission/reception packet information management 125 indicated in FIG. 7, the received packet as well as the provider session ID, source IP address, destination IP address, and protocol managed in the transmission/reception packet information management 125 indicated in FIG. 7 are notified to the mobile downlink packet conversion unit 132.

After step S4-2 of FIG. 4, the mobile downlink packet conversion unit 132 generates and inserts the PPPOE header and the PPP header to the received packet based on the information notified from the provider searching processing unit 131, and converts the packet format (step S4-3 in FIG. 4).

In the present embodiment, when the protocol notified from the provider searching processing unit 131 is TCP or UDP, the mobile downlink conversion unit 132: sets the Ethernet type of the Ethernet header to be fixed to PPP session, version of the PPPOE header as 1, the type as 1, and the code to be fixed to 0, the session identifier as the provider session ID, and the packet size to be the value acquired by adding the PPPOE+PPP header size (8) to the packet size value of IP; generates the PPPOE header; generates the protocol of the PPP header to be fixed to IP; inserts those to the received packet; and replaces the source port number of TCP or UDP with the converted source port number.

Furthermore, when the protocol notified from the provider searching processing unit 131 is other than TCP or UDP, the mobile downlink packet conversion unit 132: sets the Ethernet type of the Ethernet header to be fixed to PPP session, version of the PPPOE header as 1, the type as 1, and the code to be fixed to 0, the session identifier as the provider session ID, and the packet size to be the value acquired by adding the PPPOE+PPP header size (8) to the packet size value of IP; generates the PPPOE header; generates the protocol of the PPP header to be fixed to IP; and inserts those to the received packet.

After step S4-3 of FIG. 4, the mobile downlink packet conversion unit 132 adds the downlink traffic amount in the mobile use information management 114 (step S4-4 in FIG. 4). In the present embodiment, the connection-destination provider name whose provider session ID managed in the provider information management 123 in FIG. 6 matches the provider session ID notified from the provider searching processing unit 131 is searched; the size of the received packet is added to the uplink traffic amount under the connection-destination provider name managed in the mobile use information management 114 in FIG. 8 matching the searched connection-destination provider name; and the downlink traffic amount managed in the mobile use information management 114 in FIG. 8 is changed to the added value.

The mobile downlink packet conversion unit 132 transfers the packet converted in step S4-3 of FIG. 4 to the LAN-side NIC 10 (step S4-5 in FIG. 4), and the LAN-side NIC 10 transfers the packet to the communication device 2 (step S4-6 in FIG. 4).

By the processing of steps S4-1 to S4-6 in FIG. 4 described above, the provider searching processing unit 131 analyzes the packet received from the mobile line 4 and the mobile downlink packet conversion unit 132 converts the packet into the packet format that can be transferred to the communication device 2, so that the user side can use the mobile line 4 without conducting any special settings and the like.

Furthermore, by adding the traffic amount from the mobile line 4 to the mobile use information management 114, it is possible to manage the traffic amount of the mobile line 4 without the user side being aware at the time of using the mobile line.

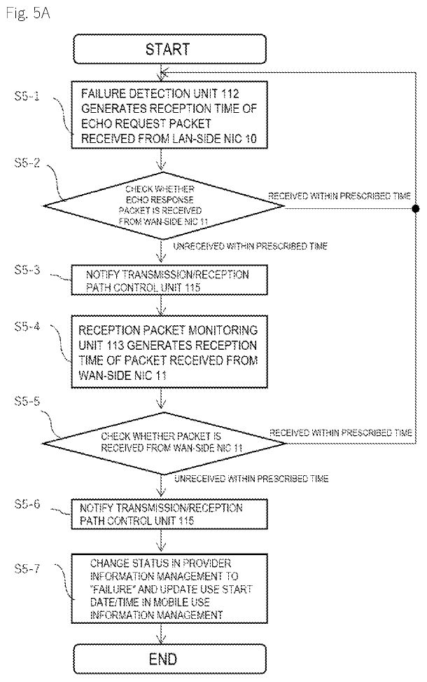

Next, a flow of failure detection processing for the wired line 3 will be described by referring to FIG. 5A.

The failure detection unit 112 extracts the Ethernet header, Point-to-Point Protocol over Ethernet (hereinafter, abbreviated as PPPOE) header, Point-to-Point Protocol (hereinafter, referred to as PPP) and PPP payload from the session maintaining request packet (packet received in step S2-1 of FIG. 2) received at the LAN-side NIC 10 from the communication device 2, and generates reception time of the extracted session maintaining request packet (step S5-1 in FIG. 5A).

With respect to the reception time of the extracted session maintaining request packet generated in step S5-1 of FIG. 5A, the failure detection unit 112 checks whether the WAN-side NIC 11 receives a session maintaining response packet from the wired line 3 within a prescribed time (step S5-2 in FIG. 5A). Note that a prescribed time in the present Description is a threshold value set in advance, and the value and setting timing thereof may be determined as appropriate in accordance with the mode of the embodiment.

In the present embodiment, with respect to the reception time of the packet where the type of the Ethernet header extracted from the session maintaining request packet in step S5-1 of FIG. 5A is the PPP session, the code of the PPPOE header is PPP, the session identifier of the PPP header is the information matching the provider session ID managed in the provider information management in FIG. 6, the protocol of the PPP header is the link control protocol (hereinafter, abbreviated as LCP) or the Internet protocol control protocol (hereinafter, abbreviated as IPCP), and the PPP code is return request (session maintaining request), the failure detection unit 112 checks whether the packet where the type of the Ethernet header of the packet extracted from the wired line 3 received at the WAN-side NIC 11 is the PPP session, the code of the PPPOE is PPP, and the protocol of the PPP header is LCP or IPCP, and the PPP code is return response (session maintaining response) is received within a prescribed time.

When the session maintaining response packet from the wired line 3 is received at the WAN-side NIC 11 within the prescribed time with respect to the reception time of the session maintaining request packet generated in step S5-1 of FIG. 5A (received within prescribed time, step S5-2 in FIG. 5A), the processing returns to step S5-1 of FIG. 5A.

The processing of steps S5-1 and S5-2 of FIG. 5A described above is repeatedly performed while the session maintaining response is being received for the session maintaining request within the prescribed time in the communication between the communication device 2 and the wired line 3, so that it is possible to check that the session is being maintained.

When the session maintaining response packet from the wired line 3 is not received at the WAN-side NIC 11 within the prescribed time with respect to the reception time of the session maintaining request packet generated in step S5-1 of FIG. 5A (unreceived within prescribed time, step S5-2 in FIG. 5A), the failure unit detection 112 notifies the transmission/reception path control unit 115 that the session maintaining response packet from the wired line 3 is not received within the prescribed time (notifies the provider session ID and that the session is disconnected) (step S5-3 in FIG. 5A).

The reception packet monitoring unit 113 extracts the Ethernet header, PPPOE header, PPP header, and PPP payload from the latest packet received at the WAN-side NIC 11 from the wired line 3 on the established session, and generates a packet reception time (step S5-4 in FIG. 5A). The latest packet received at the WAN-side NIC 11 from the wired line 3 on the established session is the packet for which the reception time is generated in step S5-4 of FIG. 5A, which corresponds to the packet that is received in step S3-1 of FIG. 3 and determined as the connected packet in S3-3. The reception packet monitoring unit 113 generates the packet reception time from the latest packet.

For the packet reception time generated in step S5-4 of FIG. 5A, the reception packet monitoring unit 113 checks whether a packet is received at the WAN-side NIC 11 from the wired line 3 within the prescribed time (step S5-5 in FIG. 5A). Reception check performed in step S5-5 is targeted at all packets received in step S3-1 of FIG. 3.

In the present embodiment, with respect to the reception time of the packet where the type of the Ethernet header extracted from the session maintaining request packet in step S5-4 of FIG. 5A is the PPP session, the code of the PPPOE header is PPP, the session identifier of the PPP header is the information matching the provider session ID managed in the provider information management of FIG. 6, and the protocol of the PPP header is the Internet protocol (hereinafter, abbreviated as IP), the reception packet monitoring unit 113 checks whether the packet under the provider session ID indicated in the provider information management 123 of FIG. 6 is received within the prescribed time from the wired line 3.

When the packet from the wired line 3 is received at the WAN-side NIC 11 within the prescribed time with respect to the reception time generated in step S5-4 of FIG. 5A (received within prescribed time, step S5-5 in FIG. 5A), the processing returns to step S5-1 of FIG. 5A.

When the packet from the wired line 3 is not received at the WAN-side NIC 11 within the prescribed time with respect to the reception time generated in step S5-4 of FIG. 5A (unreceived within prescribed time, step S5-5 in FIG. 5A), the: reception packet monitoring unit 113 notifies the transmission/reception path control unit 115 that the packet from the wired line 3 is not received within the prescribed time (notifies the provider session ID and that there is no reception packet) (step S5-6 in FIG. 5A).

Upon receiving the notification (notification indicating the provider session ID and that the session is disconnected) from the failure detection unit 112 and the notification (notification indicating the provider session ID and that there is no reception packet) from the reception packet monitoring unit 113, the transmission/reception path control unit 115 determines that there is a failure in the wired line 3, changes the status of the corresponding provider indicated in the provider information management 123 of FIG. 6 to “failure”, and registers the provider name and use start date/time indicated the mobile use information management 114 of FIG. 8.

The value set by the transmission/reception path control unit 115 is used as the value for performing mutual switching control of the transmission/reception path of the wired line 3 and the mobile line 4 in accordance with the detection results of the failure and recovery from the failure/recovery detection unit 110 that includes the failure detection unit 112 and the recovery detection unit 111. In the present embodiment, the transmission/reception path control unit 115 sets the status in the provider information management 123 of FIG. 6 to “failure” and “normal” to perform switching control of the transmission/reception path.

A session maintaining response elapsed time that is from reception of the session maintaining request packet of the communication device 2 till reception of the session maintaining response packet of the wired line 3 is checked in step S5-2 of FIG. 5A, and a packet reception elapsed time that is from reception of the packet on the latest established session till reception of the packet from the wired line 3 is checked in step S5-5 of FIG. 5A.

While steps S5-1 to S5-3 and S5-4 to S5-6 in FIG. 5A are described as a series of flow for the sake of explanations, those steps may also be executed in parallel or in random order as long as each elapsed time can be checked therewith.

Even though it is possible to determine disconnection of the maintained session based only on whether there is the session maintaining response, disconnection of the session is determined based on the session maintaining response elapsed time indicating that the session maintaining response is not received consecutively for a plurality of times. By determining it with the session maintaining response elapsed time, it becomes possible to deal with cases where packets are discarded due to network congestion and the like, for example.

Furthermore, as in the present embodiment, even in a case of a configuration where the multiprotocol/multilayer compatible relay device 1 is additionally placed between the existing communication device (router) 2 and wired line 3 and the settings such as connectivity test intervals and the like set in the existing communication device (router) 2 are black box, it is possible to perform connectivity test based on the session maintaining response elapsed time and the packet reception elapsed time without conducting initial settings and the like on the multiprotocol/multilayer compatible relay device 1.

Furthermore, at the time of failure, the transmission/reception path control unit 115 registers the failure, SO that the connection destination (transmission/reception path) from the communication device 2 is switched from the wired line 3 to the mobile line 4. Therefore, it is possible to continue the communication without the user side being aware.

Next, by referring to FIG. 5B, a flow of recovery detection processing of the wired line 3 will be described. As for the recovery detection, the recovery detection unit 111 sends a session connection request to try to establish a session for each of the connection-destination providers of the wired line 3 to detect recovery of the wired line.

For the provider whose status indicated in the provider information management 123 of FIG. 6 is “failure”, the recovery detection unit 111 transmits, to the WAN-side NIC 11, a session connection request packet (discovery stage packet and PPP session stage packet) for requesting to establish an Internet-connection session to the wired line 3 at prescribed intervals (step S5-8 in FIG. 5B), and checks whether the PPPOE session is established (step S5-9 in FIG. 5B).

When confirmed that the PPPOE session is established (session established, step S5-9 in FIG. 5B), the recovery detection unit 111 determines that recovery of the wired line 3 is detected, and notifies the detection result indicating recovery to the transmission/reception path control unit 115 (step S5-10 in FIG. 5B).

The transmission/reception path control unit 115: changes, to “normal”, the status of the provider whose provider session ID indicated in the provider information management 123 of FIG. 6 matches the provider session ID of the connection-destination provider of the wired line 3 to which the recovery detection unit 111 tried to connect; deletes (initializes) the provider session ID and all information matching the provider information ID indicated in the transmission/reception packet information management 125 of FIG. 7; and registers the provider name and the use end date/time indicated in the mobile use information management 114 of FIG. 8 (step S5-11 in FIG. 5B).

When not confirmed that the PPPOE session is established (session unestablished, step S5-9 in FIG. 5B), the processing returns to step S5-8 of FIG. 5B and a session connection request packet is transmitted until a session is established.

When a failure of the wired line 3 is detected through the processing of steps S5-1 to S5-7 of FIG. 5A described above, the transmission/reception path control unit 115 updates the status of the corresponding provider in the provider information management 123 of FIG. 6 to “failure”. Thereby, when the multiprotocol/multilayer compatible relay device 1 receives a request (communication packet) from the terminal 91, steps S2-1 to S2-3 of FIG. 2 described above are employed, the transmission/reception path is switched to the mobile line 4 in accordance with the value of the status (value “failure” set by the transmission/reception path control unit 115) extracted in S2-16, and the processing of S2-21 to S2-26 is employed. Then, the mobile uplink packet conversion unit 134 converts the format of the request (communication packet) received from the communication device 2 and transfers it to the mobile line 4 via the mobile communication unit 12.

When recovery of the wired line 3 is detected through the processing of steps S5-8 to S5-11 of FIG. 5B described above, the transmission/reception path control unit 115 updates the status of the corresponding provider in the provider information management 123 of FIG. 6 to “normal”. Thereby, when the multiprotocol/multilayer compatible relay device 1 receives a request (communication packet) from the terminal 91, steps S2-1 to S2-3 of FIG. 2 described above are employed, the transmission/reception path is switched to the wired line 3 in accordance with the value of the status (value “normal” set by the transmission/reception path control unit 115) extracted in S2-16, and the processing of S2-17 to S2-20 is employed. Then, the transmission/reception packet analysis unit 124 transfers the request (communication packet) received from the communication device 2 to the wired line 3 via the WAN-side NIC 11.

In this manner, by mutually switching the wired line 3 and the mobile line 4 in accordance with the status set by the transmission/reception path control unit 115 at the time of detecting a failure and recovery of the wired line 3, communication from the communication device 2 to the network line can be continuously used even at the time of a failure and recovery occurred in the wired line 3.

As described above, the multiprotocol/multilayer compatible relay device 1 switches the transmission/reception path between the wired line 3 and the mobile line 4 at the time of detecting a failure and recovery. However, it is also possible to provide an LED lamp or the like when designing the configuration as a hardware device, and to light it up when the mobile line 4 is in use for allowing visual recognition.

Furthermore, it is also possible to additionally provide a management function of the multiprotocol/multilayer compatible relay device 1. An example thereof may be a management screen for the like capable of managing the failure/recovery state of the wired line 3, traffic amount of the mobile line 4, and the like. Note that the management function may be determined as appropriate in accordance with the mode of the embodiment, and detailed explanations thereof are omitted.

The transmission/reception path control unit 115 keeps the use start date/time and use end date/time of the mobile line 4 in the mobile use information management 114, so that it is possible to specify the use date/time and use hours, and to calculate communication fee (use fee) for each of the connection-destination provides by using the uplink traffic amount and downlink traffic amount held in the mobile use information management 114.

When there is a failure in the wired line 3, the recovery detection unit 111 gives a session connection request at prescribed intervals. Therefore, when the wired line 3 recovers, it is possible to establish a session promptly and to detect the recovery.

Furthermore, at the time of recovery, the connection destination is switched from the mobile line 4 to the wired line 3 when the transmission/reception path control unit 115 registers normal (recovery). Therefore, it is possible to continue the communication without the user side being aware.

As described above, since the line is relayed among a plurality of lines including one or more wired lines 3 and mobile lines 4, even when there is a failure in the wired line 3, it is possible to maintain the Internet connection by switching to the mobile line 4. Furthermore, since the multiprotocol/multilayer compatible relay device 1 can be installed between the communication device 2 and the wired line 3 as well as the mobile line 4 without conducting initial settings, it is possible to achieve redundant network in a simple manner without terminating the communication connection being used and without requiring review, construction, and the like of a new network design including configuration settings of the communication device 2.

As described above, while the connection of the communication device that is connected to the first communication line can be relayed to the second communication line by configuring the multiprotocol/multilayer compatible relay device as hardware, it can also be achieved by software. By configuring a multiprotocol/multilayer compatible relay program as software and installing the software in a computer or an arithmetic calculation device mounted on hardware or by mounting a storage medium where the software is saved into the computer or arithmetic calculation device, the multiprotocol/multilayer compatible relay program can be executed.

That is, the multiprotocol/multilayer compatible relay program is designed to cause the computer to execute a failure/recovery detection function of the failure/recovery detection unit, a transmission/reception path control function of the transmission/reception path control unit, a first communication line transfer processing function of the first communication line transfer processing unit, and a second communication line transfer processing function of the second communication line transfer processing unit. In other words, the multiprotocol/multilayer compatible relay program enables the computer to implement the failure/recovery detection unit, the transmission/reception path control unit, the first communication line transfer processing unit, and the second communication line transfer processing unit by means of software.

Hereinafter, an embodiment, which executes or achieves relay, to the second communication line, connection of the communication device that is connected to the first communication line by installing the software configuring the multiprotocol/multilayer compatible relay program into the multiprotocol/multilayer compatible relay device, will be described.

The failure/recovery detection function of the multiprotocol/multilayer compatible relay program includes a function of executing the failure/recovery detection unit 110 and detecting the failure and recovery of the wired line 3 (first communication line).

The transmission/reception path control function of the multiprotocol/multilayer compatible relay program includes a function of executing the transmission/reception path control unit 115 and setting the value for performing mutual switching control of the wired line (first communication line) 3 and the mobile line (second communication line) 4 in accordance with the detection result acquired by the failure/recovery detection unit 110.

An example of the processing for detecting a failure and recovery and for setting the value for transmission/reception path switching control may be the processing described as steps S5-1 to S5-7 and S5-8 to S5-11 of FIG. 5.

The first communication line transfer processing function of the multiprotocol/multilayer compatible relay program includes a function executing the wired line transfer processing unit (first communication line transfer processing unit) 120; analyzing the packet exchanged between the communication device 2 and the connection-destination provider of the wired line 3 (first communication line) in accordance with the value for performing switching control; extracting the provider information, the session information, and the transmission/reception packet information; transferring the packet received from the communication device 2 to the interface that houses the wired line (first communication line) 3; and transferring the packet received from the interface that houses the wired line (first communication line) 3 to the communication device 2.

An example of the transfer processing of the first communication line (wired line) 3 and the communication device 2 may be the processing described as steps S2-1 to S2-3, S2-16, and S2-17 to S2-20 of FIG. 2 and steps S3-1 to S3-3 and S3-4 to S3-7 of FIG. 3.

The second communication line transfer processing function of the multiprotocol/multilayer compatible relay program includes a function of: executing the mobile line transfer processing unit (second communication line transfer processing unit) 130; analyzing the packet received from the communication device in accordance with the value for performing switching control; converting the packet received from the communication device into a format that can be transferred to the second communication line, and transferring it to the interface that houses the second communication line; and converting the packet received from the interface that houses the second communication line into a format that can be transferred to the communication device, and transferring it to the communication device.

An example of the transfer processing of the second communication line (mobile line) 4 and the communication device 2 may be the processing described as steps S2-1 to S2-3, S2-16, and S2-21 to S2-26 of FIG. 2 and steps S3-1 to S3-3 and S3-8 to S3-11 of FIG. 3.

While the mode executed or implemented by the multiprotocol/multilayer compatible relay device is described in the embodiment above, the target to install the software configuring the multiprotocol/multilayer compatible relay program is not limited to the multiprotocol/multilayer compatible relay device but may be any hardware that is capable of executing the software. As an example, the software may be installed into and executed by the user terminal or the router.

Subsequently, a multiprotocol/multilayer compatible relay method according to the embodiment of the present invention will be described.

The multiprotocol/multilayer compatible relay method according to the embodiment of the present invention is a method that is executed or achieved by the multiprotocol/multilayer compatible relay device that relays, to the second communication line, the connection the communication device that is connected to the first communication line.

A failure/recovery detection step of the multiprotocol/multilayer compatible relay method executes the failure/recovery detection unit 110 and detects a failure and recovery of the first communication line.

A transmission/reception path control step of the multiprotocol/multilayer compatible relay method executes the transmission/reception path control unit 115 and sets the value for performing mutual switching control of the first communication line and the second communication line in accordance with the detection result acquired by the failure/recovery detection step.

An example of the processing for detecting a failure and recovery and for setting the value for transmission/reception path switching control may be the processing described as steps S5-1 to S5-7 and S5-8 to S5-11 of FIG. 5.

A first communication line transfer processing step of the multiprotocol/multilayer compatible relay method: executes the wired line transfer processing unit (first communication line transfer processing unit) 120; analyzes the packet exchanged between the communication device and the connection-destination provider of the first communication line in accordance with the value for performing switching control; extracts the provider information, the session information, and the transmission/reception packet information; transfers the packet received from the communication device to the interface that houses the first communication line; and transfers the packet received from the interface that houses the first communication line to the communication device.

An example of the transfer processing of the first communication line (wired line) 3 and the communication device 2 may be the processing described as steps S2-1 to S2-3, S2-16, and S2-17 to S2-20 of FIG. 2 and steps S3-1 to S3-3 and S3-4 to S3-7 of FIG. 3.

A second communication line transfer processing step of the multiprotocol/multilayer compatible relay method: executes the mobile line transfer processing unit (second communication line transfer processing unit) 130; analyzes the packet received from the communication device in accordance with the value for performing switching control; converts the packet received from the communication device into a format that can be transferred to the second communication line, and transfers it to the interface that houses the second communication line; and converts the packet received from the interface that houses the second communication line into a format that can be transferred to the communication device, and transfers it to the communication device.

An example of the transfer processing of the second communication line (mobile line) 4 and the communication device 2 may be the processing described as steps S2-1 to S2-3, S2-16, and S2-21 to S2-26 of FIG. 2 and steps S3-1 to S3-3 and S3-8 to S3-11 of FIG. 3.

While the mode executed or implemented by the multiprotocol/multilayer compatible relay device is described in the embodiment above, the configuration is not limited thereto but any configuration capable of executing the multiprotocol/multilayer compatible relay method cay be employed as appropriate.

The present invention can be embodied in various forms without departing from the sprit and scope thereof. Thus, the embodiment described above is for illustrative purpose only, and not intended to limit the present invention.

### REFERENCE SIGNS LIST

1 Multiprotocol/multilayer compatible relay device
2 Communication device
3 Wired line (first communication line)
4 Mobile line (second communication line)
10 LAN-side NIC
11 WAN-side NIC
12 Mobile communication unit
110 Failure/recovery detection unit
111 Recovery detection unit
112 Failure detection unit
113 Reception packet monitoring unit
114 Mobile use information management
115 Transmission/reception path control unit
120 Wired line transfer processing unit (first communication line transfer processing unit)
121 Connection session analysis unit
122 Provider information analysis unit
123 Provider information management
124 Transmission/reception packet analysis unit
125 Transmission/reception packet information management
130 Mobile line transfer processing unit (second communication line transfer processing unit)
131 Provider searching processing unit
132 Mobile downlink packet conversion unit
133 Session establishing processing unit
134 Mobile uplink packet conversion unit
135 Session maintaining processing unit
91 Terminal
92 System

What is claimed is:

1. A multiprotocol/multilayer compatible relay device that relays, to a second communication line, connection of a communication device that is connected to a first communication line, the multiprotocol/multilayer compatible relay device comprising:
an interface that houses the first communication line;
an interface that houses the second communication line of a communication scheme different from the first communication line;
an interface connecting to the communication device;
a failure/recovery detection unit that detects a failure and recovery of the first communication line;
a transmission/reception path control unit that sets a value for performing mutual switching control of a transmission/reception path between the first communication line and the second communication line in accordance with a detection result acquired by the failure/recovery detection unit;
a first communication line transfer processing unit that: transfers a packet received from the communication device to the interface that houses the first communication line; and transfers a packet received from the interface that houses the first communication line to the communication device; and
a second communication line transfer processing unit that: converts format of the packet received from the communication device and transfers the packet to the interface that houses the second communication line; and converts a format of the packet received from the interface that houses the second communication line and transfers the packet to the communication device,
the multiprotocol/multilayer compatible relay device:
relaying connection of the communication device to the second communication line by switching the transmission/reception path from the first communication line to the second communication line based on the value set by the transmission/reception path control unit, when failure is detected by the failure/recovery detection unit; and
relaying connection of the communication device to the first communication line by switching the transmission/reception path from the second communication line to the first communication line based on the value set by the transmission/reception path control unit, when recovery from the failure is detected by the failure/recovery detection unit.

2. The multiprotocol/multilayer compatible relay device according to claim 1, wherein
in a case where the first communication line is a wired line, and the second communication line is a mobile line,
the interface that houses the first communication line is a WAN-side NIC,
the interface that houses the second communication line is a mobile communication unit,
the interface connecting to the communication device is a LAN-side NIC,
the wired line comprises a wired line transfer processing unit that is the first communication line transfer processing unit, the wired line transfer processing unit comprising: a provider information analysis unit that analyzes a connection-destination provider of the wired line; a connection session analysis unit that analyzes a connection session with the wired line; and a transmission/reception packet analysis unit that analyzes a packet notified from the connection session analysis unit,
the failure/recovery detection unit comprises: a reception packet monitoring unit that monitors the packet from the wired line; a failure detection unit that detects a failure of the wired line; a recovery detection unit that detects recovery of the wired line; a mobile use information management that manages use information of the mobile line; and the transmission/reception path control unit,
the mobile line comprises a mobile line transfer processing unit that is the second communication line transfer processing unit, the mobile line transfer processing unit comprising: a provider searching processing unit that searches for a provider; a session establishing processing unit that establishes an Internet connection from the communication device to the wired line when there is a failure in the wired line; a session maintaining processing unit that maintains the Internet connection of an Internet-connected session; a mobile uplink packet conversion unit that converts a format of a transmission/reception packet that varies between a case of using the wired line and a case of using the mobile line, and transfers the transmission/reception packet to the mobile communication unit; and a mobile downlink packet conversion unit that converts a format of a transmission/reception packet that varies between the wired line and the mobile line, and transfers the transmission/reception packet to the LAN-side NIC.

3. The multiprotocol/multilayer compatible relay device according to claim 2, wherein
the failure detection unit: generates a session maintaining request packet reception time from a latest session maintaining request packet received from the communication device; and when a session maintaining response packet is not received from the wired line within a prescribed time with respect to the session maintaining request packet reception time, detects and notifies non-reception to the transmission/reception path control unit,
the reception packet monitoring unit: generates a packet reception time from a latest packet received from the wired line; and when a packet is not received from the wired line within a prescribed time with respect to the packet reception time, detects and notifies non-reception to the transmission/reception path control unit,
the transmission/reception path control unit has a function of determining a failure based on notification from the failure detection unit and notification from the reception packet monitoring unit, and
the recovery detection unit has a function of detecting recovery of the wired line by trying to establish a session through requesting session connection to each of the connection-destination providers of the wired line.

4. The multiprotocol/multilayer compatible relay device according to claim 3, wherein
the wired line transfer processing unit comprises provider information management and transmission/reception packet information management,
the provider information analysis unit: analyzes a packet exchanged between the communication device and the connection-destination provider of the wired line; and extracts provider information including connection-destination provider name, connection-destination account and password, connection authentication method, and IP address assigned from the provider,
the transmission/reception packet analysis unit: analyzes a packet transmitted/received between the communication device and the connection-destination provider of the wired line; and extracts transmission/reception packet information including connection protocol information, source IP address, destination IP address, and port number,
the provider information management manages the provider information for each of the connection-destination providers of the wired line, and
the transmission/reception packet information management manages the transmission/reception packet information for each of the connection-destination providers of the wired line.

5. The multiprotocol/multilayer compatible relay device according to claim 4, wherein
the session maintaining processing unit comprises a session maintainer configured to maintain a session through giving a session maintaining response in a pseudo manner for a session maintaining request given to the wired line from the communication device, when a failure of the wired line is detected, and
the session establishing processing unit comprises a session establisher configured to establish, in a pseudo manner, an Internet-connection session from the communication device to the wired line by giving a session connection response in response to a new session connection request from the communication device to the wired line based on information including connection-destination provider, account, password, authentication method, and IP address.

6. The multiprotocol/multilayer compatible relay device according to claim 5, wherein
the mobile uplink packet conversion unit comprises a converter configured to convert a packet format of a communication packet transmitted from the communication device on the session that is established in a pseudo manner upon detecting the failure of the wired line into a packet format of a case that uses the mobile line based on information including source IP address, destination IP address, protocol, and port number transmitted/received on the provider, and
the mobile downlink packet conversion unit comprises a converter configured to convert a packet format of a communication packet transmitted from the mobile line into a packet format from the connection-destination provider of the wired line based on the information including the source IP address, the destination IP address, the protocol, and the port number transmitted/received on the provider.

7. The multiprotocol/multilayer compatible relay device according to claim 6, wherein the mobile use information management holds information including use start date/time and use end date/time of the mobile line as well as a traffic amount of the mobile line.

8. A multiprotocol/multilayer compatible relay program for relaying, to a second communication line, connection of a communication device that is connected to a first communication line, the multiprotocol/multilayer compatible relay program causing a computer to execute:
a failure/recovery detection function that detects a failure and recovery of the first communication line; a transmission/reception path control function that sets a value for performing mutual switching control of a transmission/reception path between the first communication line and the second communication line in accordance with a detection result acquired by the failure/recovery detection function;
a first communication line transfer processing function that: analyzes a packet exchanged between the communication device and a connection-destination provider of the first communication line in accordance with a value for performing the switching control; extracts provider information, session information, and transmission/reception packet information; transfers a packet received from the communication device to an interface that houses the first communication line; and transfers a packet received from an interface that houses the first communication line to the communication device; and
a second communication line transfer processing function that: analyzes the packet received from the communication device in accordance with the value for performing the switching control; converts a format of the packet received from the communication device into a: format that can be transferred to the second communication line and transfers the packet to the interface that houses the second communication line; and converts a format of the packet received from the interface that houses the second communication line into a format that can be transferred to the communication device and transfers the packet to the communication device.

9. A multiprotocol/multilayer compatible relay method for relaying, to a second communication line, connection of a communication device that is connected to a first communication line, the multiprotocol/multilayer compatible relay method comprising:
detecting a failure and recovery of the first communication line;
setting a value for performing mutual switching control of a transmission/reception path between the first communication line and the second communication line in accordance with a detection result acquired by the detecting;
analyzing a packet exchanged between the communication device and a connection-destination provider of the first communication line in accordance with a value for performing the switching control; extracting provider information, session information, and transmission/reception packet information; transferring a packet received from the communication device to an interface that houses the first communication line; and transferring a packet received from an interface that houses the first communication line to the communication device; and
analyzing the packet received from the communication device in accordance with the value for performing the switching control; converting a format of the packet received from the communication device into a format that can be transferred to the second communication line and transferring the packet to the interface that houses the second communication line; and converting a format of the packet received from the interface that houses the second communication line into a format that can be transferred to the communication device and transferring the packet to the communication device.
